(19) United States
(12) Patent Application Publication
(10) Pub. No.: US 2018/0141432 A1
(43) Pub. Date: May 24, 2018

(54) RESERVOIR WITH RATCHETING SUPPORT STRUCTURE

(71) Applicant: Ford Global Technologies, LLC, Dearborn, MI (US)

(72) Inventors: Joseph Demaria, New Hudson, MI (US); Dennis Michael Harrigan, SR., Monroe, MI (US); Frank Joseph Topolovec, Canton, MI (US); Daniel Frank Cragel, Livonia, MI (US)

(21) Appl. No.: 15/360,760

(22) Filed: Nov. 23, 2016

(51) Int. Cl. B60K 15/03

(52) U.S. Cl. CPC B60K 15/03

(57) ABSTRACT

Methods and systems are provided for a reservoir including a ratcheting support column. In one example, a support column for a reservoir includes a first portion and a second portion configured to move toward each other when pressed together. The first portion and second portion do not move away from each other when they are urged in opposite directions.

### FIELD

The present description relates generally to methods and systems for a fluid reservoir, such as a fuel tank of a motorized vehicle.

### BACKGROUND/SUMMARY

A fluid reservoir, such as a fuel tank of a motorized vehicle, may include an outer shell enclosing an interior of the reservoir. Fluid (in one example, a fuel such as gasoline) may flow into the interior via an aperture positioned along the outer shell. For example, a fluid passage such as a hose may be coupled with the aperture, and fluid may flow through the hose and into the interior of the reservoir to be stored within the reservoir. In some applications, fluid may be stored within the reservoir at a high pressure.

Attempts to increase a strength and durability of a fluid reservoir include coupling a structural member between interior walls of the reservoir to reduce an amount of deflection of the walls of the reservoir when the walls are subjected to various forces (e.g., forces due to fluid pressure, impacts, etc.). One example approach is shown by Varga in U.S. Pat. No. 8,490,807. Therein, a fuel container formed by two shells is disclosed, with an inner column coupled to each of the two shells and extending between the two shells. The column is formed in two parts, with the first part including latching hooks and the second part including catches. Another example approach is shown by Quant et al. in U.S. Patent 2015/0344183. Therein, a fuel tank is disclosed having a top and a bottom supported together by at least one column-shaped supporting element. The supporting element has a one-piece solid profile with a ribbed cross-section. Yet another example approach is shown by Clayton et al. in U.S. Pat. No. 6,135,306. Therein, a fuel tank includes a columnar member extending between upper and lower walls of the fuel tank. The columnar member includes a spring and may expand or contract in response to forces applied to the walls of the fuel tank.

However, the inventors herein have recognized potential issues with such systems. As one example, a supporting member (e.g., column) formed as one solid piece may not be able to contract in response to forces applied to outer walls of a reservoir containing the member. While an incompressible column may increase a deflection resistance of the outer walls, a force with a large enough magnitude applied to the outer walls may cause the outer walls to separate at one or more locations where the walls are joined with the column due to the incompressibility of the column. Similarly, a supporting column formed by a first part having hooks and a second part having latches may also be incompressible in response to the force applied to the outer walls. As another example, a supporting member configured to expand or contract via a spring in response to forces applied to the outer walls may not be suitable for applications in which fluid is stored within the reservoir with a high pressure. For example, high fluid pressure may apply an expansion force to the walls of the reservoir, and the expansion force may have a higher magnitude than a restoring force of the spring (e.g., a force urging the spring back to its equilibrium position in which the spring is neither compressed nor stretched). As a result, the walls of the reservoir may become bowed as fluid pressure presses the walls outward in a direction away from an interior of the reservoir, thereby causing an undesirable deformation of the reservoir.

In one example, the issues described above may be addressed by a method for a support structure for a reservoir, comprising: a first portion coupled to a first wall of the reservoir and including a plurality of circumferential notches formed by an inner surface; and a second portion coupled to a second wall of the reservoir and including a plurality of angled extensions formed by an outer surface, the plurality of angled extensions shaped to fit within the plurality of circumferential notches. Due to this configuration of the angled extensions and the circumferential notches, the first portion and second portion may move in a direction toward each other when pressed together, but may not move in a direction away from each other when pulled in opposite directions. As a result, an amount of deflection of outer walls of the reservoir may be reduced and a durability of the reservoir is increased.

As one example, the first portion may be shaped to partially surround the second portion. The plurality of angled extensions may be shaped to slide across the plurality of circumferential notches when the first portion and second portion are pressed together, but may also be shaped to lock into the circumferential notches when the first portion and second portion are urged apart. The angled extensions may be shaped to slide across the circumferential notches when a magnitude of an inward force against outer walls of the reservoir exceeds a threshold amount. In this way, the first portion and second portion may move together in response to a strong impact against the outer walls of the reservoir, thereby reducing a strain against the outer walls and increasing a durability and impact resistance of the reservoir.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic depiction of an engine system including a fuel tank with a support column.

FIG. 2 shows a side view of a fuel tank including a support column positioned at a center of the fuel tank, with the support column in a fully extended position.

FIG. 3 shows three views of a first portion and a second portion of the support column in various positions relative to each other.

FIG. 4 shows a side view of the fuel tank of FIG. 2, with the support column in a fully contracted position.

FIG. 5 shows a side view of a fuel tank including two ratcheting support columns positioned around a midpoint of the fuel tank, with the support columns in a fully extended position.

FIG. 6 shows a side view of the fuel tank of FIG. 5, with the support columns in a partially contracted position.

### DETAILED DESCRIPTION

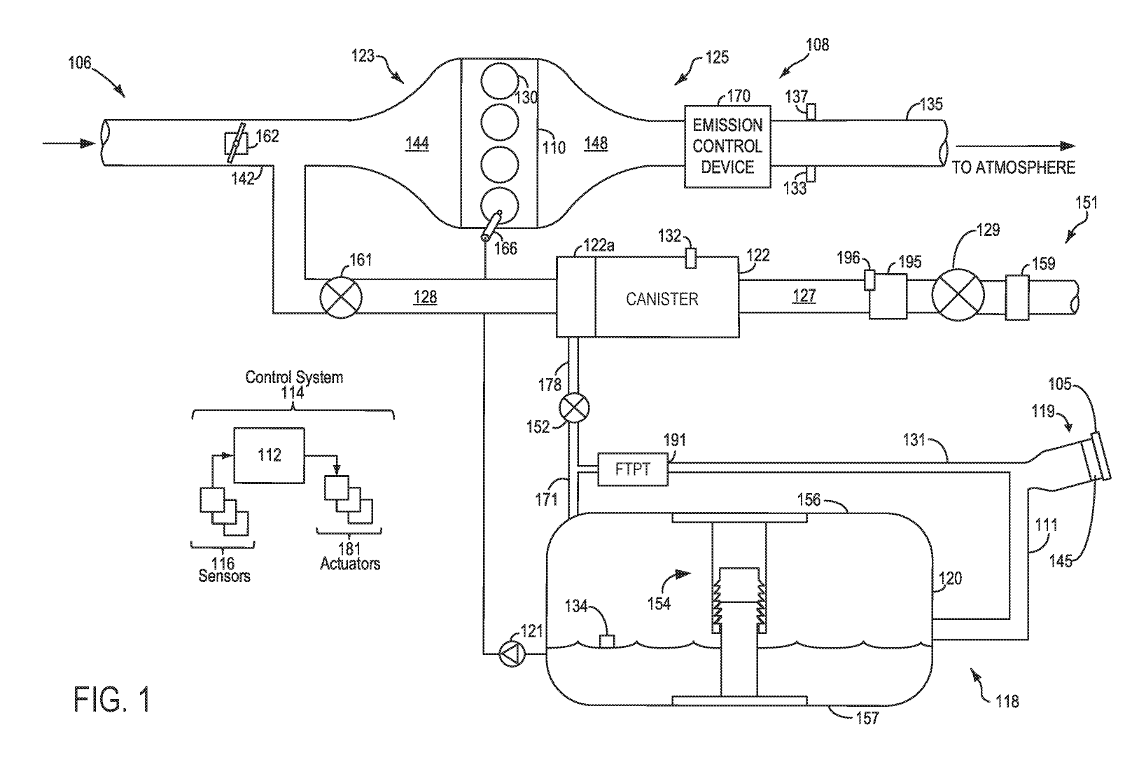

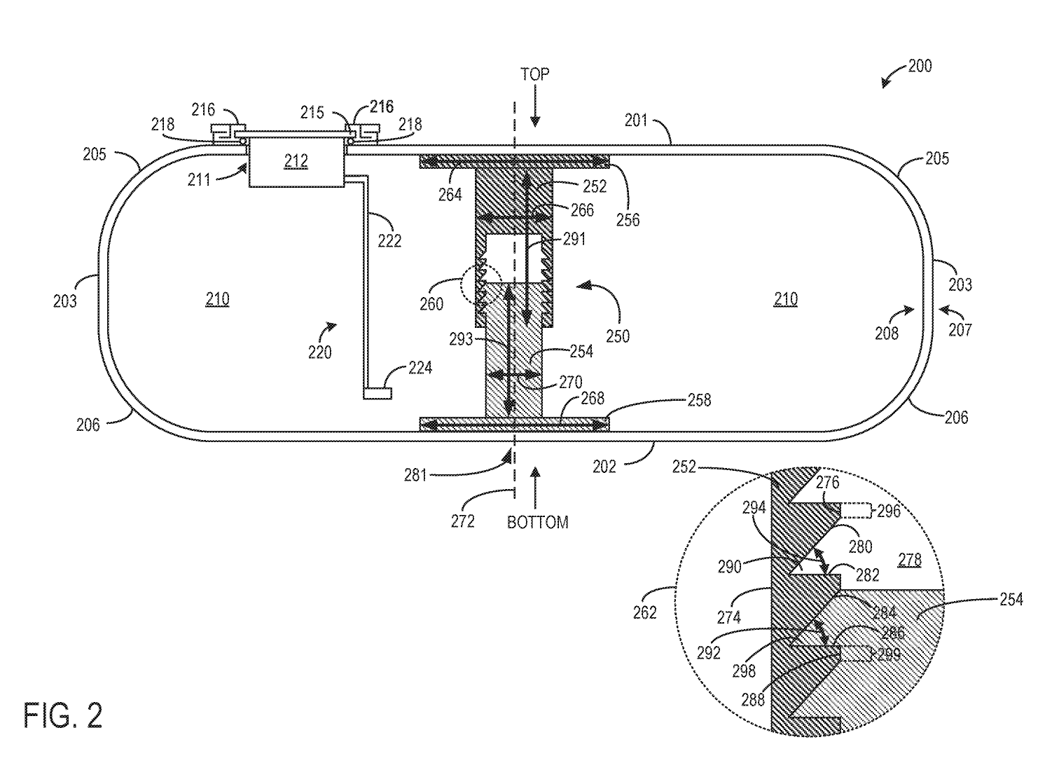

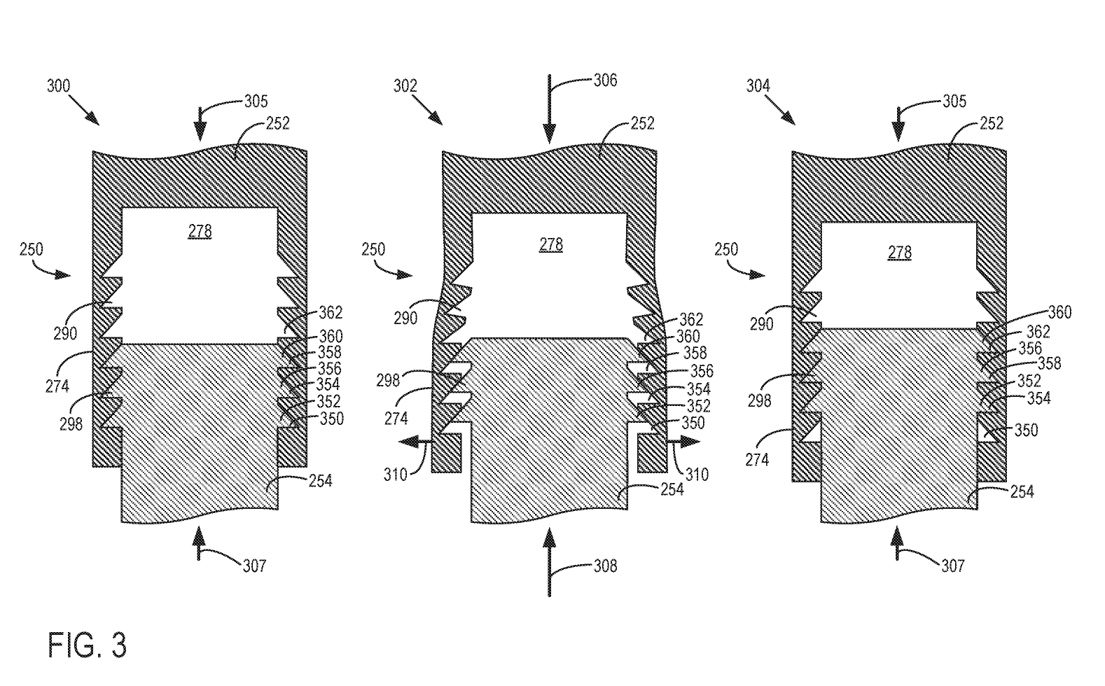

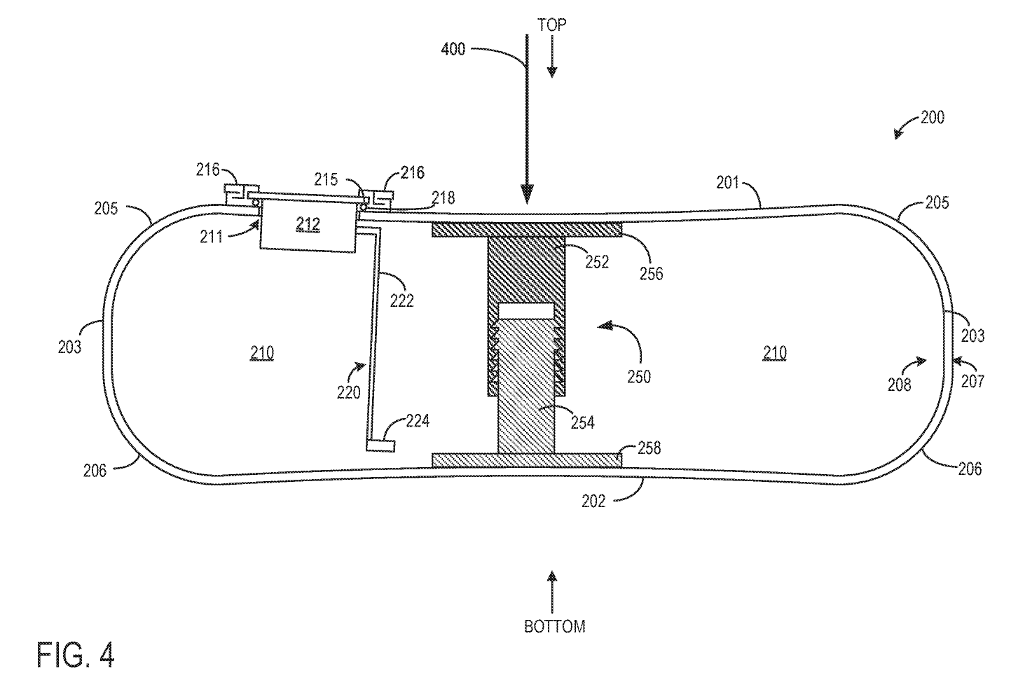

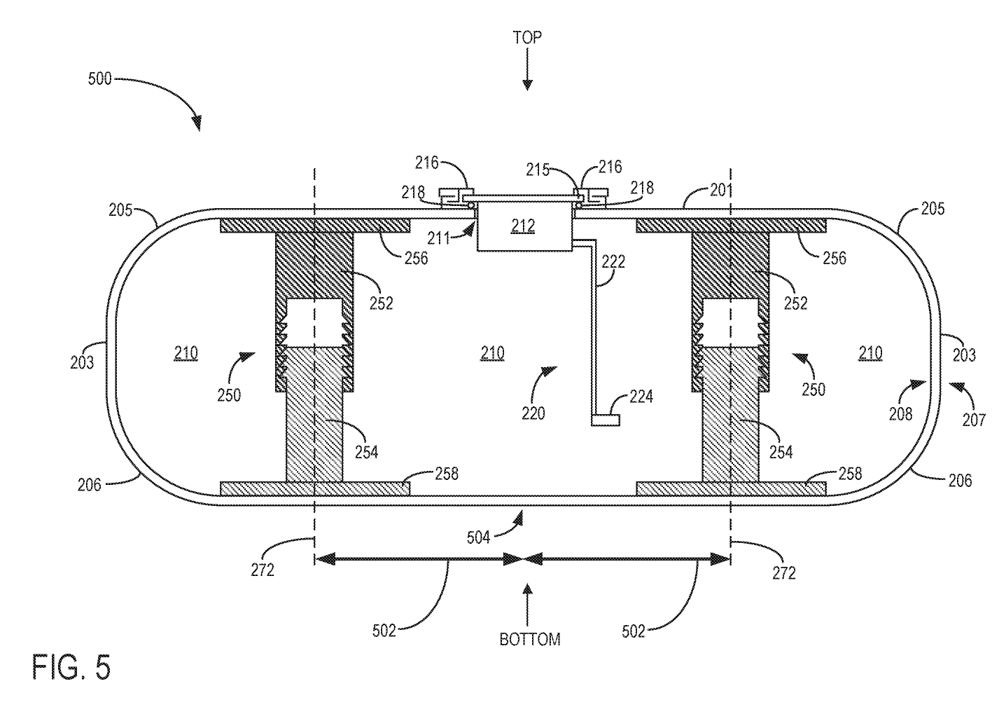

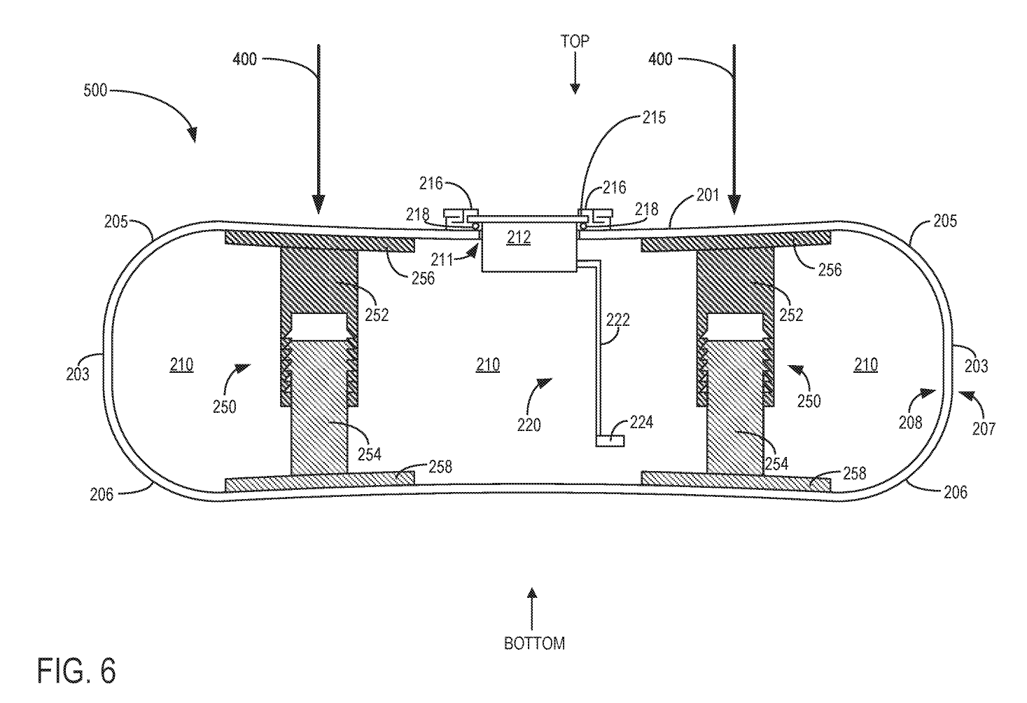

The following description relates to systems and methods for a reservoir including a ratcheting support structure (which may be referred to herein as a support column). A fluid reservoir may be configured to store fluid at various pressures. In one example, the fluid reservoir may be a fuel tank included within an engine system, such as the engine system shown by FIG. 1. In this example, the fuel tank stores a fuel (e.g., gasoline) for use by the engine. The fuel tank may include a single support column, as shown by FIG. 2, or the fuel tank may include a plurality of support columns, as shown by FIG. 5. Each support column includes a first portion coupled to a first wall of the fuel tank and a second portion coupled to a second wall of the fuel tank. The first portion includes a plurality of circumferential notches formed by an inner surface of the first portion. The second portion includes a plurality of angled extensions shaped to slide against and engage with the circumferential notches when the first portion and second portion are pressed together. The circumferential notches and angled extensions permit the first portion and second portion to move toward each other but do not permit the first portion and second portion to move away from each other. The first portion and second portion may be pressed together when an inward force is applied to an outer shell of the fuel tank, as shown by FIG. 4 and FIG. 6. The first portion and second portion may be locked together in a plurality of positions, as shown by FIG. 3. In this way, the support column increases a rigidity of the fuel tank by decreasing an amount of deflection of the first wall and second wall when the fuel tank is pressurized, and increases a resistance of the fuel tank to inward forces (e.g., impacts).

FIG. 1 shows a schematic depiction of a vehicle system 106. The vehicle system 106 includes an engine system 108 coupled to an emission control system 151 and a fuel system 118. Emission control system 151 may include a fuel vapor container 122 (which may be referred to herein as a canister) to capture and store fuel vapors. In some examples, vehicle system 106 may be a hybrid electric vehicle system.

The engine system 108 may include an engine 110 having a plurality of cylinders 130. The engine 110 includes an intake system 123 and an engine exhaust 125. The intake system 123 includes a throttle 162 fluidly coupled to the engine intake manifold 144 via an intake passage 142. The engine exhaust 125 includes an exhaust manifold 148 leading to an exhaust passage 135 that routes exhaust gas to the atmosphere. The engine exhaust 125 may include one or more emission control devices 170, which may be mounted in a close-coupled position in the exhaust. One or more emission control devices may include a three-way catalyst, lean NOx trap, diesel particulate filter, oxidation catalyst, etc. It will be appreciated that other components may be included in the engine such as a variety of valves and sensors.

Fuel system 118 includes a fuel tank 120 coupled to a fuel pump system 121. The fuel pump system 121 may include one or more pumps for pressurizing fuel delivered to fuel injectors of engine 110, such as the example fuel injector 166 shown. While only a single fuel injector 166 is shown, additional fuel injectors are provided for each cylinder. It will be appreciated that fuel system 118 may be a return-less fuel system, a return fuel system, or various other types of fuel system. Fuel tank 120 may hold a plurality of fuel blends, including fuel with a range of alcohol concentrations, such as various gasoline-ethanol blends, including E10, E85, gasoline, etc., and combinations thereof. A fuel level sensor 134 located in fuel tank 120 may provide an indication of the fuel level (“Fuel Level Input”) to controller 112. As depicted, fuel level sensor 134 may comprise a float connected to a variable resistor. Alternatively, other types of fuel level sensors may be used.

In one example, the outer walls of fuel tank 120 may be composed at least partially of polymer or plastic materials. In another example, the outer walls of the fuel tank 120 may be composed at least partially of metal. In yet another example, the outer walls of the fuel tank 120 may be composed of a combination of metal and plastic materials. By reducing the thickness and/or rigidity of the outer walls, fuel tank 120 may be reduced in weight. In order to increase a strength and durability of fuel tank 120, ratcheting support column 154 is coupled between top wall 156 and bottom wall 157. Support column 154 increases an amount of structural support and/or rigidity of the fuel tank 120. Further details regarding the fuel tank and support column and their function are described further below with reference to FIGS. 2-6.

Vapors generated in fuel system 118 may be routed to emission control system 151 which includes canister 122 via vapor recovery line 131, before being purged to the intake system 123. Vapor recovery line 131 may be coupled to fuel tank 120 via one or more conduits 178 and may include one or more valves for isolating the fuel tank during certain conditions. For example, vapor recovery line 131 may be coupled to fuel tank 120 via conduit 171.

In some examples, a fuel tank vent valve 152 may be coupled with conduit 171. Fuel tank vent valve 152 may allow canister 122 of the emissions control system 151 to be maintained at a low pressure or vacuum without increasing the fuel evaporation rate from the tank (which would otherwise occur if the fuel tank pressure were lowered). The fuel tank vent valve 152 may be electronically or mechanically actuated valve. In one example, the fuel tank vent valve 152 may be actuated to an opened or closed position by controller 112. In another example, fuel tank vent valve 152 may be a passive valve (e.g., a valve with no moving parts that is actuated to an opened or closed position passively in response to fuel tank fill level and without actuation by the controller 112). In one example, fuel tank vent valve 152 may be normally open to increase a flow of diurnal and “running loss” vapors from the fuel tank to the canister 122, thereby decreasing a pressure of fuel within the fuel tank 120. However, during vehicle operation on an incline, when a fuel level as indicated by fuel level sensor 134 is artificially raised on one side of the fuel tank, fuel tank vent valve 152 may be closed to prevent liquid fuel from entering vapor recovery line 131. As another example, fuel tank vent valve 152 may be closed during fuel tank refilling, thereby causing pressure to build in vapor recovery line 131 as well as at a filler nozzle coupled to the fuel pump. The increase in pressure at the filler nozzle may then actuate a pressure sensor at the refueling pump to stop the fuel fill process automatically and preventing overfilling.

Vapor recovery line 131 is coupled to a refueling system 119. In some examples, refueling system 119 may include a fuel cap 105 for sealing off the fuel filler system from the atmosphere. Refueling system 119 is coupled to fuel tank 120 via a fuel filler pipe 111 (which may be referred to herein as a filler neck). Further, refueling system 119 may include refueling lock 145. In some embodiments, refueling lock 145 may be a fuel cap locking mechanism. The fuel cap locking mechanism may be configured to automatically lock the fuel cap in a closed position so that the fuel cap cannot be opened. In one example, the fuel cap 105 may remain locked via refueling lock 145 while pressure or vacuum in the fuel tank is greater than a threshold. In response to a refuel request, e.g., a vehicle operator initiated request, the fuel tank may be depressurized and the fuel cap may be unlocked after the pressure or vacuum in the fuel tank falls below a threshold. A fuel cap locking mechanism may be a latch or clutch, which, when engaged, prevents the removal of the fuel cap. The latch or clutch may be electrically locked, for example, by a solenoid, or may be mechanically locked, for example, by a pressure diaphragm.

Emissions control system 151 may include one or more emissions control devices, such as one or more fuel vapor canisters (e.g., canister 122) filled with an appropriate adsorbent (e.g., activated carbon). The one or more fuel vapor canisters are configured to temporarily trap fuel vapors (including vaporized hydrocarbons) during fuel tank refilling operations and “running loss” (that is, fuel vaporized during vehicle operation) as described above. Emissions control system 151 may further include a canister ventilation path 127 (which may be referred to herein as a vent line) which may route gases out of the canister 122 to the atmosphere when storing, or trapping, fuel vapors from fuel system 118.

Canister 122 may include a buffer 122a (or buffer region), with each of the canister and the buffer comprising the adsorbent. As shown, the volume of buffer 122a may be smaller than (e.g., a fraction of) the volume of canister 122. The adsorbent in the buffer 122a may be same as, or different from, the adsorbent in the canister (e.g., both may include activated carbon). Buffer 122a may be positioned within canister 122 such that during canister loading, fuel tank vapors are first adsorbed within the buffer, and then when the buffer is saturated, further fuel tank vapors are adsorbed in the canister. In comparison, during canister purging, fuel vapors are first desorbed from the canister (e.g., to a threshold amount) before being desorbed from the buffer. In other words, loading and unloading of the buffer is not linear with the loading and unloading of the canister. As such, the effect of the canister buffer is to dampen any sudden increases in fuel vapor flowing from the fuel tank to the canister, thereby reducing the possibility of any fuel vapor spikes going to the engine. One or more temperature sensors 132 may be coupled to and/or within canister 122. As fuel vapor is adsorbed by the adsorbent in the canister, heat is generated (heat of adsorption). Likewise, as fuel vapor is desorbed by the adsorbent in the canister, heat is consumed. In this way, the adsorption and desorption of fuel vapor by the canister may be monitored and estimated based on temperature changes within the canister.

Vent line 127 may also allow fresh air to be drawn into canister 122 when purging stored fuel vapors from fuel system 118 to intake system 123 via purge line 128 and purge valve 161. For example, purge valve 161 may be normally closed but may be opened during certain conditions so that vacuum from engine intake manifold 144 is provided to the fuel vapor canister for purging. In some examples, vent line 127 may include an air filter 159 disposed therein upstream of a canister 122.

Flow of air and vapors between canister 122 and the atmosphere may be regulated by a canister vent valve 129. Canister vent valve 129 may be a normally open valve, so that fuel tank vent valve 152 may control venting of fuel tank 120 with the atmosphere. Fuel vapors may then be vented to atmosphere via canister vent valve 129, or purged to intake system 123 via purge valve 161.

Fuel system 118 may be operated by controller 112 in a plurality of modes by selective adjustment of the various valves and solenoids. For example, the fuel system may be operated in a fuel vapor storage mode (e.g., during a fuel tank refueling operation and with the engine not running), wherein the controller 112 may open fuel tank vent valve 152 and canister vent valve 129 while closing purge valve 161 to direct refueling vapors into canister 122 while preventing fuel vapors from being directed into the intake manifold 144.

As another example, the fuel system may be operated in a refueling mode (e.g., when fuel tank refueling is requested by a vehicle operator), wherein the controller 112 may open fuel tank vent valve 152 and canister vent valve 129, while maintaining purge valve 161 closed, to depressurize the fuel tank before allowing enabling fuel to be added therein. As such, fuel tank vent valve 152 may be kept open during the refueling operation to allow refueling vapors to be stored in the canister. After refueling is completed, fuel tank vent valve 152 may remain open or may be closed (e.g., closed by the controller 112).

As yet another example, the fuel system may be operated in a canister purging mode (e.g., after an emission control device light-off temperature has been attained and with the engine running), wherein the controller 112 may open purge valve 161 and canister vent valve 129 while closing fuel tank vent valve 152. Herein, the vacuum generated by the intake manifold 144 of the operating engine 110 may be used to draw fresh air through vent line 127 and through canister 122 to purge the stored fuel vapors into intake manifold 144. In this mode, the purged fuel vapors from the canister are combusted in the engine. The purging may be continued until the stored fuel vapor amount in the canister is below a threshold.

Controller 112 may comprise a portion of a control system 114. The controller 112 receives signals from the various sensors of FIG. 1 and employs the various actuators of FIG. 1 to adjust engine operation based on the received signals and instructions stored on a memory of the controller 112. As one example, sensors 116 may include exhaust gas sensor 137 located upstream of the emission control device, temperature sensor 133, fuel tank pressure sensor 191, fuel level sensor 134, and canister temperature sensor 132. Other sensors such as pressure, temperature, air/fuel ratio, and crash sensors may be coupled to various locations in the vehicle system 106. As another example, actuators 181 may include fuel injector 166, throttle 162, fuel tank vent valve 152, ELCM 195, and refueling lock 145.

Leak detection routines may be intermittently performed by controller 112 on fuel system 118 to confirm that the fuel system is not degraded. As such, leak detection routines may be performed while the engine is off (engine-off leak test) or while the engine is running using engine-off natural vacuum (EONV) and/or vacuum supplemented from a vacuum pump. In one example, leak tests may be performed by evaporative leak check module (ELCM) 195 communicatively coupled to controller 112. As an example, ELCM 195 is shown coupled in vent line 127 between canister 122 and the atmosphere. ELCM 195 may include a vacuum pump configured to apply a negative pressure to the fuel system during a leak test. ELCM 195 may further include a reference orifice and a pressure sensor 196. A change in pressure at the reference orifice (e.g., an absolute change or a rate of change) may be monitored and compared to a threshold to diagnose a fuel system leak.

FIG. 2 and FIGS. 4-6 each show example fuel tanks which may be included within an engine system such as the engine system 108 described above with reference to FIG. 1. FIG. 2 and FIG. 4 each show a first embodiment of a fuel tank, with the fuel tank including a single support column. FIG. 2 shows the support column in a fully extended position and FIG. 4 shows the support column in a fully contracted position. FIG. 3 shows an example transitional position of the support column. FIGS. 5-6 each show a second embodiment of a fuel tank, with the fuel tank including two support columns. FIG. 5 shows the support columns in a fully extended position and FIG. 6 shows the support columns in a partially contracted position.

FIG. 2 depicts an example fuel tank 200. Fuel tank 200 includes a top wall 201 and an opposing bottom wall 202. Top wall 201 and bottom wall 202 join at sidewalls 203 of fuel tank 200. The top wall 201, bottom wall 202, and sidewalls 203 may be referred to together herein as outer walls. As described above with reference to fuel tank 120 of FIG. 1, fuel tank 200 may be configured to store and assist in delivery of fuel to an engine.

In some examples, the outer walls (201, 202, and 203) of fuel tank 200 may be composed at least partially of polymer or plastic materials. For example, the outer walls of fuel tank 200 may be composed at least partially of high density polyethylene (HDPE) and may be produced by a suitable molding process (e.g., using a blow molding or a twin sheet thermoforming process). In a blow molding process, for example, a mass of liquid plastic at elevated temperature may be expanded in a mold by injecting gas under pressure into the plastic mass to form the fuel tank. In another example in which the outer walls are formed by twin sheet thermoforming, two sheets may be extruded from an HDPE resin and may form two separate halves of the fuel tank outer walls. During the forming process auxiliary components of the fuel system may be positioned and installed on the inner walls of the tank. The two halves of the outer walls of the tank may then be brought together while still molten to seal them into a fuel tank shell. In other examples, fuel tank 200 may be produced via a split blow molding process wherein a single molded body is cut in half so that various auxiliary components of the fuel system may be positioned and installed on the inner wall of the tank. The two halves of the outer walls of the tank may then be welded together into a fuel tank shell. In some examples, the outer walls of fuel tank 200 may be composed of polyolefins, thermoplastic polyesters, polyketones, polyamides and copolymers thereof. A blend of polymers or copolymers may also be used, as may a blend of polymers with inorganic, organic and/or natural fillers, such as, for example but not limited to: carbon, salts and other inorganic derivatives, natural or polymer fibers. It is also possible to use multilayer structures made up of stacked and bonded layers comprising at least one of the polymers or copolymers described above.

The sidewall 203 of fuel tank 200 forms a perimeter around the fuel tank. In some examples, one or more corners of the fuel tank may be rounded or curved so as to reduce accumulation of fuel in corners of the fuel tank. For example, the sidewall may include regions 205 and 206, which are at least partially rounded or curved in a direction extending from the top wall to the bottom wall of the fuel tank. Additionally, sidewall 203 may be at least partially curved along one or more regions of the perimeter of fuel tank 200. In some examples, top wall 201 and bottom wall 202 may have at least partially curved regions to accommodate internal components, to increase stiffness, to reduce sloshing noise, and/or to accommodate fuel tank packaging limitations. For example, the fuel tank may be formed as a substantially rectangular box shape with curved corners, as shown in FIG. 2. However, it should be understood that a variety of fuel tank shapes may be used while remaining within the scope of this disclosure.

Top wall 201, bottom wall 202, and sidewall 203 of fuel tank 200 are coupled (e.g., fused) together into a single unit having an exterior surface 207 and an interior surface 208. The outer walls of fuel tank 200 form an enclosure or substantially hollow body 210 (which may be referred to herein as an interior of the fuel tank) wherein fuel may be stored. In some examples, hollow body 210 may be substantially sealed to reduce evaporative fuel emissions (e.g. via a fuel tank vent valve 152) as described with reference to FIG. 1. Interior surface 208 may comprise a barrier layer that is non-reactive with the fuel stored within hollow body 210, for example, ethylene vinyl alcohol or a copolymer thereof.

Top wall 201 may be formed to include a number of apertures, such as aperture 211. As an example, aperture 211 may be substantially circular. Aperture 211 may be sized to enable the insertion of fuel system components, which may include a fuel pump, a fuel filter, a fuel sender assembly, and/or other various fuel system components, actuators, and sensors. Other apertures (not shown) may enable the coupling of conduits, valves, etc. to fuel tank 200. As with the example of fuel tank 120 coupled to conduit 171 shown by FIG. 1, top wall 201 of fuel tank 200 may be shaped to couple with a fluid conduit (not shown). Similarly, sidewall 203 may include an aperture which may be coupled to a fuel filler pipe or neck (e.g., fuel filler pipe 111 coupled to fuel tank 120 as shown by FIG. 1).

A top cap 212 may be inserted in aperture 211 to effectively seal hollow body 210. However, top cap 212 may include holes, conduits, or other components to facilitate the delivery of fuel out of fuel tank 200. Top cap 212 may include flange 215 (which may be referred to herein as a lip) configured to overlap a region of the top wall 201 adjacent to a perimeter of the aperture 211. Flange 215 may also be substantially circular with an outer flange diameter larger than the diameter of aperture 211, and thus may assist in sealing of the aperture.

Top cap 212 may include or be integrated with locking components 216. In some examples, the locking components may be made of a metal (e.g., steel) or plastic. In one example, locking components 216 may be integrally molded to top cap 212. As another example, locking components 216 may be mechanically coupled to the top cap 212, e.g., using various fasteners such as bolts, screws, and the like. In this example, two locking components 216 are shown on opposing sides of aperture 211. However, additional locking components may be included. In some examples, a continuous locking ring may be used.

Locking components 216 may be configured to couple top cap 212 to top wall 201. For example, locking components 216 may be configured to clamp down flange 215 to top wall 201. Thus, one or more components may be included on the top wall of the fuel tank adjacent to the aperture and configured to couple with corresponding elements of locking components 216. As shown in FIG. 2, at least a portion of locking components 216 may overlap with the top wall 201 of the fuel tank so that they may be coupled thereto.

In some examples, a sealing member 218 (e.g., an O-ring) may be disposed between flange 215 and top wall 201 to assist in sealing of aperture 211 when top cap 212 is in an installed position with the locking components in place. Top cap 212 and locking components 216 may be installed in an orientation to create a sufficient amount of pressure on sealing member 218 to hermetically seal the gap between flange 215 and top wall 201.

Top cap 212 may include a plurality of fuel system components coupled thereto. In the example shown by FIG. 2, top cap 212 is shown coupled to fuel level indicator 220, which may be configured to sense a fuel level in the fuel tank. In other examples, fuel level indicator 220 may be coupled to a fuel delivery module, other internal component, or may be coupled to interior surface 208.

Fuel level indicator 220 includes a pivotal arm 222 and a float device 224 coupled to pivotal arm 222. For example, as a fuel level in the fuel tank increases, the float device 224 may rise with increasing fuel level causing pivotal arm 222 to rotate. Fuel level indicator 220 may be coupled to various components, such as one or more resistors, which may convert the rotational position of pivotal arm 222 to an electrical signal readable by a controller (e.g., controller 112 shown by FIG. 1). Fuel level indicator 220 may also be coupled to one or more valves (e.g., fuel tank vent valve 152 shown by FIG. 1). The one or more valves may be configured to close responsive to float device 224 reaching a threshold distance from top wall 201, thereby sealing fuel tank 200 and generating a back-pressure which may be used to automatically end a refueling event.

The outer walls of fuel tank 200 may be subjected to pressure and vacuum changes. In one example, pressure and vacuum changes may include differences between a pressure of atmospheric air around the tank body (e.g., around the outer walls) and a pressure of a gaseous mixture of air and fuel vapor within the fuel tank body (e.g., within the hollow body 210). For example, when gas pressure within the fuel tank 200 exceeds atmospheric pressure, the fuel tank 200 may be referred to herein as pressurized. When gas pressure within the fuel tank 200 is equal to or less than atmospheric pressure, the fuel tank 200 may be referred to herein as depressurized.

In the first embodiment of the fuel tank shown by FIG. 2 and FIG. 4, the fuel tank 200 includes a support column 250 positioned at a center of the fuel tank 120. During some conditions (such as conditions in which the fuel tank 120 is pressurized), the support column 250 may reduce an amount of deflection (e.g., bowing) of the outer walls, as described below.

The amount of deflection a region of an outer wall of the fuel tank experiences may depend on a variety of properties of the fuel tank. For example, the amount of deflection a region of an outer wall of the fuel tank is subjected to may depend on the shape of the fuel tank, thickness of the walls of the fuel tank, components attached to the outer walls of the fuel tank, materials used in construction of the fuel tank, etc.

For example, one or more regions of top wall 201 and bottom wall 202 may be subjected to a greater amount of deflection during pressure and vacuum changes than regions of fuel tank 200 adjacent to the perimeter of the fuel tank. For example, center regions of top wall 201 and bottom wall 202 positioned substantially equidistant from diametrically opposed locations along the perimeter of the fuel tank may be subjected to a greater amount of deflection during pressure and vacuum changes than regions of the outer walls of the fuel tank adjacent to the perimeter. Regions of the outer walls of fuel tank 200 adjacent to the perimeter may have increased rigidity due to structural support conferred by sidewall 203, for example.

In order to at least partially reduce deflections in the outer walls of the fuel tank 120, the fuel tank 200 includes support column 250 coupled between the top wall 201 and the bottom wall 202. Although the support column 250 is shown positioned in a center of the fuel tank 200 and extending between the top wall 201 and the bottom wall 202, in some examples, the support column 250 may instead be coupled to the fuel tank 200 at a different location. For example, in embodiments in which the outer walls of the fuel tank 200 are in a different arrangement than the arrangement shown by FIG. 2, the support column 250 may be positioned in a region of the fuel tank 200 in which the outer walls are subjected to a greatest amount of deflection when the fuel tank 200 is pressurized. Support column 250 may increase a rigidity to fuel tank 200, and may protect fuel tank 200 from deformation during extreme temperatures.

Support column 250 is depicted as a columnar structure. Other support features or means of increasing the rigidity of fuel tank 200, externally and/or internally may be used along with support column 250. The support column 250 may be made from the same material as the outer walls of fuel tank 200, or may be made from another material that is non-reactive with fuel stored in hollow body 210 (or may be made of a combination of materials). In some examples, support column 250 may comprise one or more apertures, baffles, or other features configured to reduce fuel sloshing. Apertures may further reduce the volume of the support column 250, thereby increasing the amount of fuel that may be stored in fuel tank 200.

Support column 250 may be strategically placed based on deformation models of fuel tank 200. The placement of support column 250 may further be based on the positioning of other components within fuel tank 200. For example, support column 250 may be placed so as not to interfere with the movement of float device 224 or pivotal arm 222. As shown in FIG. 2, the support column 250 and pivotal arm 222 are offset from one another in the fuel tank 200. The installation of support column 250 within fuel tank 200 may be performed before and/or after the installation of other internal componentry, depending on the configuration of fuel tank 200.

Support column 250 may increase the durability of the fuel tank and limit the expansion and contraction of the fuel tank due to internal pressure or vacuum. The support column 250 may be strategically positioned based on modeling and/or physical studies that indicate where fuel tank 200 is likely to deflect the most due to increased pressure or vacuum. Thus, the support column 250 provides a counter-acting force, maintaining the distance between corresponding points on top wall 201 and bottom wall 202 that is robust to changes in fuel tank pressure (e.g., over a diurnal cycle).

Support column 250 includes a first portion 252 coupled to (e.g., directly coupled to) top wall 201 by a first bracket 256 (which may be referred to herein as a base). Support column 250 additionally includes a second portion 254 coupled to (e.g., directly coupled to) bottom wall 202 by a second bracket 258 (which may be referred to herein as a base). In one example, first portion 252 and first bracket 256 may be formed together (e.g., fused) as one piece, and the second portion 254 and second bracket 258 may be formed together as one piece. In other examples, the first portion 252 and/or second portion 254 may instead be mechanically coupled to first bracket 256 and second bracket 258 (respectively) via one or more fasteners (e.g., bolts). Similarly, the first bracket 256 and second bracket 258 may be fused or mechanically coupled with the corresponding walls of the fuel tank 200 (e.g., top wall 201 and bottom wall 202, respectively). Support column 250 is shown by FIG. 2 in a fully extended position, with the first portion 252 and second portion 254 locked together (as described below).

In one example, the first bracket 256 and/or second bracket 258 may each have a circular or elliptical profile and a thickness such that the first bracket 256 and/or second bracket 258 are approximately disc-shaped. In some examples, a first diameter 264 of the first bracket 256 and a second diameter 268 of the second bracket 258 may be approximately a same amount of length. The first diameter 264 of the first bracket 256 may be a greater amount of length than a first width 266 of the first portion 252. Similarly, the second diameter 268 of the second bracket 258 may be a greater amount of length than a second width 270 of the second portion 254. By configuring the first diameter 264 of the first bracket 256 and the second diameter 268 of the second bracket 258 to be greater than the first width 266 of the first portion 252 and the second width 270 of the second portion 254 (respectively), forces applied to the outer walls of the fuel tank 200 (e.g., forces due to impacts against the outer walls, pressure differences between the interior and exterior of the fuel tank, etc.) may be more evenly transmitted to the support column 250. In this way, the support column 250 may reduce an amount of deflection of the outer walls and increase a durability of the fuel tank 200.

The first portion 252 and the second portion 254 of the support column 250 are locked together and shaped such that forces applied to the outer walls may move the first portion 252 and second portion 254 toward each other in a direction along central axis 272 of the support column 250, but forces applied to the outer walls do not move the first portion 252 and second portion 254 away from each other in a direction along the central axis 272. In other words, the first portion 252 and second portion 254 are configured to ratchet together, toward each other. For example, during conditions in which the fuel tank 200 is pressurized as described above, the pressure of fuel within the hollow body 210 of the fuel tank 200 applies an outward force (e.g., a force directed away from the hollow body 210 of the fuel tank 200) to both of the top wall 201 and the bottom wall 202, thereby urging the top wall 201 and bottom wall 202 away from each other. However, due to the coupling of the support column 250 between the top wall 201 and the bottom wall 202, the support column 250 increases a resistance of the top wall 201 and bottom wall 202 to the outward force described above. In other words, because the first portion 252 and second portion 254 of the support column 250 are configured such that the first portion 252 and second portion 254 do not move away from each other, and because the top wall 201 is coupled to the first portion 252 via the first bracket 256 and the bottom wall 202 is coupled to the second portion 254 via the second bracket 258, the top wall 201 and bottom wall 202 similarly do not move away from each other in response to the outward force. In one example, the central axis 272 of the support column 250 is positioned to intersect a midpoint 281 of the fuel tank 200 in order to increase a durability of the fuel tank 200 at its midpoint 281.

In another example, during conditions in which a pressure of fuel and/or air within the fuel tank 200 is less than atmospheric pressure (e.g., a pressure of air surrounding an exterior of the fuel tank 200), the atmospheric air applies an inward force (e.g., a force directed toward the hollow body 210 of the fuel tank 200) to both of the top wall 201 and bottom wall 202, thereby urging the top wall 201 and bottom wall 202 toward each other. However, although the first portion 252 and second portion 254 are configured to move together in response to an inward force applied to the top wall 201 and bottom wall 202, the first portion 252 and second portion 254 are shaped such that they do not move together when a magnitude of the inward force applied to the top wall 201 and bottom wall 202 is less than a threshold amount.

For example, during some condition in which a pressure of fuel and/or air within the fuel tank 200 is less than atmospheric pressure (e.g., during a leak test of fuel tank 200), an inward force against the top wall 201 and bottom wall 202 resulting from a pressure difference between the interior and exterior of the fuel tank 200 may not be great enough to move the first portion 252 and second portion 254 in a direction toward each other. In one example, atmospheric pressure may correspond to 0 pounds per square inch (PSI), and a pressure of fuel and/or air within the fuel tank 200 may be between 0 and −3 PSI. In this example, the first portion 252 and second portion 254 may be configured to move together when a difference (e.g., a threshold difference) between atmospheric pressure and the pressure of fuel/air within the fuel tank 200 exceeds 20 PSI. As a result, because the difference between atmospheric pressure and the pressure of fuel and/or air within the fuel tank 200 is less than 20 PSI, the first portion 252 and second portion 254 do not move together (and therefore, the top wall 201 and bottom wall 202 do not move together). In this way, the support column 250 reduces an amount of deflection of the outer walls resulting from inward forces applied to the outer walls. In other examples, the threshold difference may correspond to a different amount, such as 30 PSI, 40 PSI, etc.

A shape of the first portion 252 and the second portion 254 may determine the threshold amount of inward force applied to the top wall 201 and bottom wall 202 at which the first portion 252 and second portion 254 begin to move together. In the examples shown by FIGS. 2-6, the first portion 252 is shaped to at least partially surround the second portion 254, such that the second portion 254 presses into an interior of the first portion 252 in response to inward forces applied to the outer walls (as described above). Different shapes and/or configurations of the first portion 252 and second portion 254 may result in different threshold amounts of inward force. Particular examples are described below.

Inset 262 shows an enlarged view of region 260 of support column 250, including first portion 252 and second portion 254. First portion 252 is shown to include an outer surface 274, an inner surface 276, and a plurality of ramped surfaces 280 angled relative to a plurality of radial surfaces 282. The radial surfaces 282 are arranged radially relative to the central axis 272. In other words, each radial surface 282 extends away from the central axis 272 and is perpendicular relative to the central axis 272. Second portion 254 includes an outer surface 288, a plurality of angled surfaces 284, and a plurality of extension surfaces 286. In the example shown, the surfaces listed above (e.g., outer surface 274, inner surface 276, ramped surfaces 280, radial surfaces 282, outer surface 288, angled surfaces 284, and extension surfaces 286) extend circumferentially around the central axis 272 such that the first portion 252 and second portion 254 are approximately cylindrical in shape.

The ramped surfaces 280 are joined with the radial surfaces 282 to form a plurality of circumferential notches 290 within an interior 278 of the first portion 252. The ramped surface 280 of each circumferential notch 290 is angled by an angle 294 relative to the corresponding radial surfaces 282 to which the ramped surface 280 is joined. The radial surfaces 282 extend in a radial direction relative to the central axis 272. The ramped surfaces 280 are joined with the radial surfaces 282 at ends of the radial surfaces 282 positioned furthest from the central axis 272. The ramped surfaces 280 each extend from their joined location with the radial surfaces 282 in a direction toward the central axis 272 and top wall 201.

In the examples shown by FIGS. 2-6, the ramped surfaces 280 and radial surfaces 282 form six circumferential notches 290 within the interior 278 of the first portion 252, with each circumferential notch 290 distanced from each adjacent circumferential notch 290 in a direction of central axis 272 by a length 296 of inner surface 276. In some examples, a different number of circumferential notches 290 may be formed within the interior 278 of the first portion 252, such as five notches, seven notches, eight notches, etc. In some examples, one or more of the ramped surfaces 280 may be angled relative to the radial surfaces 282 by a different amount (e.g., an amount between zero and ninety degrees). In yet other examples, the length 296 between one or more of the circumferential notches 290 may be a different amount of length, and/or a length of one or more of the radial surfaces 282 and/or ramped surfaces 280 may be different than the examples shown by FIGS. 2-6.

The second portion 254 of the support column 250 is shown to include a plurality of angled extensions 298 formed by the angled surfaces 284 and extension surfaces 286. The extension surfaces 286 extend in a radial direction relative to the central axis 272. The angled surfaces 284 are angled relative to the extension surfaces 286 by an angle 292. Each angled surface 284 is joined with a corresponding extension surface 286 at an end of the extension surface 286 positioned further from the central axis 272. In one example, the angle 292 between each angled surface 284 and the corresponding extension surface 286 may be a same amount of angle as angle 294. In other examples, the angle 292 may be a different amount of angle than angle 294. Each angled extension 298 is distanced from each adjacent angled extension 298 in a direction of the central axis 272 by a length 299 of the outer surface 288. In some examples (such as those shown by FIGS. 2-6), the length 299 is the same amount of length as the length 296. In other examples, the length 299 may be a different amount of length than the length 296. In yet other examples, the amount angle 292 and/or the amount of length 299 may be different for one or more of the angled extensions 298. In other words, one or more of the angled extensions 298 may have a different angle 292 and/or length 299 than at least one other angled extension 298.

In each example, the various lengths and angles of the circumferential notches 290 and angled extensions 298 are configured such that the angled extensions 298 fit within the circumferential notches 290. The number of circumferential notches 290 may be greater than the number of angled extensions 298. For example, in the examples shown by FIGS. 2-6, the first portion 252 includes six circumferential notches 290 and the second portion 254 includes three angled extensions 298. When an inward force is applied to the top wall 201 and/or bottom wall 202 with a magnitude greater than the threshold amount as described above, the first portion 252 and second portion 254 are configured to move together by sliding the angled extensions 298 along the circumferential notches 290 in a direction of the central axis 272. In one example, an axial length 291 of the first portion 252 may be greater than an axial length 293 of the second portion 254 so that the second portion 254 may fit at least partially inside of the first portion 252 when the first portion 252 and second portion 254 are moved together. An example movement of the angled extensions 298 relative to the circumferential notches 290 is shown by FIG. 3 and described below.

FIG. 3 shows several views of the first portion 252 and second portion 254 of support column 250 positioned relative to each other. In particular, first view 300 shows the first portion 252 and second portion 254 in a first locked position in which a magnitude of inward forces (indicated by arrow 305 and arrow 307) against the outer walls of the fuel tank (e.g., fuel tank 200 of FIG. 2) does not exceed the threshold amount (as described above). Second view 302 shows the first portion 252 and second portion 254 in a first transitional position, with the first portion 252 and second portion 254 moved toward each other relative to the first position shown by first view 300 in response to the magnitude of the inward forces (indicated by arrow 306 and arrow 308) exceeding the threshold amount. Third view 304 shows the first portion 252 and second portion 254 in a second locked position relative to each other, with the movement of the first portion 252 and second portion 254 from the first locked position to the second locked position resulting from the increased inward forces shown by second view 302.

As shown by first view 300 and described above with reference to FIG. 2, the angled extensions 298 are shaped to fit within the circumferential notches 290 and retain a position of the first portion 252 and second portion 254 relative to each other when outward forces (as described above) are applied to the outer walls of the fuel tank. In other words, when the first portion 252 and second portion 254 are urged away from each other, the angled extensions 298 and circumferential notches 290 lock together to prevent the first portion 252 and second portion 254 from moving apart. For example, in response to outward forces, the extension surfaces 286 press against the radial surfaces 282 but do not move because the extension surfaces 286 and radial surfaces 282 are arranged perpendicular to the direction of the outward forces. In this way, when the fuel tank is pressurized as described above, the support column 250 reduces a deflection of the outer walls.

However, when a magnitude of inward forces exceeds the threshold amount as described above and as shown by second view 302, the angled surfaces 284 press against the ramped surfaces 280 and force the first portion 252 to expand momentarily in an outward direction perpendicular with the central axis 272 (as indicated by arrows 310), thereby allowing the first portion 252 and second portion 254 to slide toward each other in the direction of the central axis 272. In other words, the angled extensions 298 may slide across (e.g., ratchet along) the circumferential notches 290 when the magnitude of inward forces exceeds the threshold amount (and the angled extensions 298 do not slide across the circumferential notches 290 when the magnitude of inward forces does not exceed the threshold amount). In one example, the outer surface 274 of the first portion 252 may include one or more features configured to increase an expandability of the first portion 252 in the outward direction indicated by arrows 310. For example, outer surface 274 may include one or more slots extending in a direction parallel with the central axis 272 and arranged around a perimeter of the outer surface 274. Alternate embodiments may include additional features configured to increase the expandability of the first portion and/or a different arrangement and/or shape of the features (e.g., one or more slots arranged around the perimeter of the outer surface 274 and extending angularly relative to the central axis 272).

In one example, the first portion 252 and second portion 254 may slide together such that a first angled extension 350 initially positioned within a first circumferential notch 352, a second angled extension 354 initially positioned within a second circumferential notch 356, and a third angled extension 358 initially positioned within a third circumferential notch 360 (as shown by first view 300) may be shifted to a second position in which the first angled extension 350 is positioned within the second circumferential notch 356, the second angled extension 354 is positioned within the third circumferential notch 360, and the third angled extension 358 is positioned within a fourth circumferential notch 362. In other words, each of the angled extensions 298 may be moved from a first position in which they are coupled with a first group of the circumferential notches 290 to a second position in which the angled extensions 298 are coupled with a second group of the circumferential notches 290, with the second group positioned further toward the top wall 201 (shown by FIG. 2) than the first group. In some examples, the threshold amount of inward forces at which the angled extensions 298 slide across (e.g., ratchet along) the circumferential notches 290 is determined by an amount of angle 292 and an amount of angle 294 (shown by FIG. 2). For example, when the angle 292 and the angle 294 are each sixty degrees, the threshold amount of inward forces may be less compared to a configuration in which the angle 292 and the angle 294 are each thirty degrees. As another example, in some embodiments the angle 292 and the angle 294 may be a different amount of angle for one or more angled extensions 298 and circumferential notches 290, respectively. In such embodiments, the threshold amount of inward forces may increase or decrease as the first portion 252 and second portion 254 are moved closer together.

In this way, the first portion 252 and second portion 254 may move toward each other in response to a strong inward force (e.g., a force against the exterior of the fuel tank in a direction of the interior of the fuel tank) against the outer walls of the fuel tank, but do not move away from each other in response to outward forces (e.g., forces against the interior of the fuel tank in a direction of the exterior of the fuel tank) against the outer walls. In one example, a strong inward force (e.g., an inward force with a magnitude exceeding the threshold amount) may be a force of impact against the outer walls of the fuel tank. By moving the first portion 252 and second portion 254 together in response to the strong inward force, an amount of stress along the outer walls of the fuel tank at locations where the support column is coupled to the outer walls may be reduced, thereby increasing a durability of the fuel tank.

FIG. 4 shows the fuel tank 200 of FIG. 2 in a condition in which the first portion 252 and second portion 254 have moved toward each other, as described above with reference to third view 304 shown by FIG. 3. In this condition, although the top wall 201 and bottom wall 202 are urged toward each other by the relative position of the first portion 252 and second portion 254 of the support column 250, the movement of the first portion 252 and second portion 254 toward each other increases a resistance of the fuel tank 200 to a force of impact (indicated by arrow 400).

FIGS. 5-6 each show a second embodiment of a fuel tank, with the fuel tank 500 shown by FIGS. 5-6 including two support columns 250. The fuel tank 500 includes two support columns 250 positioned around a midpoint 504 of the fuel tank 500 such that a distance 502 of the central axis 272 of each support column 250 to the midpoint 504 is a same amount of distance. By positioning the support columns in this way, a durability of the fuel tank 500 may be further increased. For example, FIG. 5 shows each support column 250 in a fully extended position, wherein a magnitude of inward forces against the outer walls of the fuel tank 500 does not exceed a threshold amount (as described above). However, FIG. 6 shows inward forces with an increased magnitude indicated by arrows 400 against the outer walls of the fuel tank 500. As a result of the inward forces shown by FIG. 6, the support columns 250 are moved into a partially contracted position. In one example, the magnitude of the inward forces shown by FIG. 6 may be a same amount as the inward forces shown by FIG. 4. As a result of the inclusion of two support columns 250 by the fuel tank 500 compared to the single support column 250 included by fuel tank 200 (shown by FIG. 2 and FIG. 4), the amount of contraction of the support columns 250 of fuel tank 500 is less than the amount of contraction of support column 250 of fuel tank 200 when the same amount of inward force is applied to the outer walls. In this way, a plurality of support columns may further increase a durability of the fuel tank by distributing the inward forces across the plurality of support columns and increasing the threshold amount of inward forces. In other examples, a different number and/or arrangement of support columns may be included by the fuel tank. For example, a fuel tank may include three support columns, four support columns, etc., and/or one or more support columns may be positioned a different distance from the midpoint of the fuel tank.

The technical effect of including at least one ratcheting support column within a reservoir (e.g., a fuel tank) as described above is to enable the outer walls of the reservoir to deflect inward and prevent the outer walls of the reservoir from deflecting outward. The support column includes a first portion coupled to a first wall of the reservoir and a second portion coupled to a second wall of the reservoir. The first portion and second portion may move toward each other and may not move away from each other. In this way, a durability of the reservoir in response to inward forces and outward forces against the outer walls may be increased. For example, in response to a strong inward force against the outer walls of the reservoir, the support column may contract in order to reduce an amount of strain on the outer walls resulting from the increased force or impact. In another example, in response to a lesser inward force against the outer walls of the reservoir (e.g., an inward force with a lesser magnitude than the strong inward force described above, such as a force applied during a leak test), the support column may not contract in order to maintain a volume of the fuel tank. In another example, in response to an outward force against the outer walls, the support column may resist extension in order to increase a rigidity of the reservoir. The support column thus increases the durability of the reservoir for a variety of conditions.

FIGS. 2-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

In one embodiment, a reservoir includes: a support structure including: a first portion coupled to a first wall of the reservoir and including a plurality of circumferential notches formed by an inner surface; and a second portion coupled to a second wall of the reservoir and including a plurality of angled extensions formed by an outer surface, the plurality of angled extensions shaped to fit within the plurality of circumferential notches. In a first example of the reservoir, a first diameter of the first portion is greater than a second diameter of the second portion, and the inner surface of the first portion at least partially surrounds the outer surface of the second portion. A second example of the reservoir optionally includes the first example, and further includes wherein each angled extension of the plurality of angled extensions include: an extension surface arranged perpendicular with a central axis of the support structure and extending from the outer surface in a direction away from the central axis; and an angled surface arranged at a first angle relative to the extension surface and extending from the extension surface to the outer surface in a direction toward the central axis and first wall. A third example of the reservoir optionally includes one or both of the first and second examples, and further includes wherein each circumferential notch of the plurality of circumferential notches includes: a radial surface arranged perpendicular with the central axis of the support structure and extending from the inner surface in a direction away from the central axis; and a ramped surface arranged at a second angle relative to the radial surface and extending from the radial surface to the inner surface in a direction toward the central axis and first wall. A fourth example of the reservoir optionally includes one or more or each of the first through third examples, and further includes wherein the first angle and the second angle are a same amount of angle. A fifth example of the reservoir optionally includes one or more or each of the first through fourth examples, and further includes wherein a total number of angled extensions of the plurality of angled extensions is less than a total number of circumferential notches of the plurality of circumferential notches. A sixth example of the reservoir optionally includes one or more or each of the first through fifth examples, and further includes wherein the first portion and the second portion are movable in a direction toward each other but are not movable in a direction away from each other. A seventh example of the reservoir optionally includes one or more or each of the first through sixth examples, and further includes wherein the central axis of the support structure is positioned at a midpoint of the reservoir. An eighth example of the reservoir optionally includes one or more or each of the first through seventh examples, and further includes wherein the first portion and second portion include one or more apertures configured to flow fluid within the reservoir through the support structure. A ninth example of the reservoir optionally includes one or more or each of the first through eighth examples, and further includes wherein the support structure is one of a plurality of support structures positioned within an interior of the reservoir, with each support structure of the plurality of support structures including one of the first portion and one of the second portion. A tenth example of the reservoir optionally includes one or more or each of the first through ninth examples, and further includes wherein each support structure of the plurality of support structures is positioned a same distance around a midpoint of the reservoir.

In one embodiment, a support column for a reservoir includes: a first portion including a plurality of circumferential notches formed by an inner surface; and a second portion including a plurality of angled extensions formed by an outer surface and shaped to couple with the plurality of circumferential notches, the plurality of angled extensions configured to slide across the plurality of circumferential notches in a first direction and to not slide in a second direction opposite to the first direction. In a first example of the support column, the support column includes a first base coupled to a first end of the first portion and a second base coupled to a first end of the second portion, wherein a second end of the first portion surrounds a second end of the second portion. A second example of the support column optionally includes the first example, and further includes wherein the first direction is a direction toward the first base of the first portion and parallel to a central axis of the support column, and wherein the second direction is a direction away from the first base and parallel to the central axis. A third example of the support column optionally includes one or both of the first and second examples, and further includes wherein the first portion and second portion are configured to move from a fully extended position to a locked position via a transitional position in response to a force with a magnitude greater than a threshold amount pressing the first portion and second portion together, wherein the locked position is one of a plurality of locked positions in which an extension surface of each angled extension of the plurality of angled extensions is in face-sharing contact with a radial surface of a corresponding circumferential notch of the plurality of circumferential notches. A fourth example of the support column optionally includes one or more or each of the first through third examples, and further includes wherein the transitional position of the support column is one of a plurality of transitional positions in which the extension surface of each angled extension is not in face-sharing contact with the radial surface of the corresponding circumferential notch. A fifth example of the support column optionally includes one or more or each of the first through fourth examples, and further includes wherein the fully extended position of the support column includes the first base of the first portion being a first distance from the second base of the second portion, a fully contracted position of the support column includes the first base being a second distance from the second base, wherein the fully extended position and fully contracted position are each one of the plurality of locked positions, and wherein the first distance is greater than the second distance.

In one embodiment, a fuel system includes: a fuel tank including: at least one support column disposed within the fuel tank, the support column including: a first portion and a second portion, with the first portion and second portion configured to move toward each other when pressed together and to not move away from each other when urged apart. In a first example of the fuel system, the fuel system includes a plurality of circumferential notches formed by an inner surface of the first portion and a plurality of angled extensions form by an outer surface of the second portion, with the plurality of angled extensions shaped to fit within the plurality of circumferential notches. A second example of the fuel system optionally includes the first example, and further includes wherein the first portion of the support column is coupled to a first wall of the fuel tank and the second portion of the support column is coupled to a second wall of the fuel tank, with the first wall arranged parallel and opposite to the second wall.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A reservoir, comprising:
a support structure including:
a first portion coupled to a first wall of the reservoir and including a plurality of circumferential notches formed by an inner surface; and
a second portion coupled to a second wall of the reservoir and including a plurality of angled extensions formed by an outer surface, the plurality of angled extensions shaped to fit within the plurality of circumferential notches.

2. The reservoir of claim 1, wherein a first diameter of the first portion is greater than a second diameter of the second portion, and wherein the inner surface of the first portion at least partially surrounds the outer surface of the second portion.

3. The reservoir of claim 2, wherein each angled extension of the plurality of angled extensions include:
an extension surface arranged perpendicular with a central axis of the support structure and extending from the outer surface in a direction away from the central axis; and
an angled surface arranged at a first angle relative to the extension surface and extending from the extension surface to the outer surface in a direction toward the central axis and first wall.

4. The reservoir of claim 3, wherein each circumferential notch of the plurality of circumferential notches includes:
a radial surface arranged perpendicular with the central axis of the support structure and extending from the inner surface in a direction away from the central axis; and
a ramped surface arranged at a second angle relative to the radial surface and extending from the radial surface to the inner surface in a direction toward the central axis and first wall.

5. The reservoir of claim 4, wherein the first angle and the second angle are a same amount of angle.

6. The reservoir of claim 5, wherein a total number of angled extensions of the plurality of angled extensions is less than a total number of circumferential notches of the plurality of circumferential notches.

7. The reservoir of claim 6, wherein the first portion and the second portion are movable in a direction toward each other but are not movable in a direction away from each other in each case with at least one of the plurality of angled extensions positioned and in locking engagement within one of the plurality of circumferential notches.

8. The reservoir of claim 3, wherein the central axis of the support structure is positioned at a midpoint of the reservoir.

9. The reservoir of claim 1, wherein the first portion and second portion include one or more apertures configured to flow fluid within the reservoir through the support structure.

10. The reservoir of claim 1, wherein the support structure is one of a plurality of support structures positioned within an interior of the reservoir, with each support structure of the plurality of support structures including one of the first portion and one of the second portion.

11. The reservoir of claim 10, wherein each support structure of the plurality of support structures is positioned a same distance around a midpoint of the reservoir.

12. A support column for a reservoir, comprising:
a first portion including a plurality of circumferential notches formed by an inner surface; and
a second portion including a plurality of angled extensions formed by an outer surface and shaped to couple with the plurality of circumferential notches, the plurality of angled extensions configured to slide across the plurality of circumferential notches in a first direction and to not slide in a second direction opposite to the first direction.

13. The support column of claim 12, further comprising a first base coupled to a first end of the first portion and a second base coupled to a first end of the second portion, wherein a second end of the first portion surrounds a second end of the second portion.

14. The support column of claim 13, wherein the first direction is a direction toward the first base of the first portion and parallel to a central axis of the support column, and wherein the second direction is a direction away from the first base and parallel to the central axis.

15. The support column of claim 14, wherein the first portion and second portion are configured to move from a fully extended position to a locked position via a transitional position in response to a force with a magnitude greater than a threshold amount pressing the first portion and second portion together, wherein the locked position is one of a plurality of locked positions in which an extension surface of each angled extension of the plurality of angled extensions is in face-sharing contact with a radial surface of a corresponding circumferential notch of the plurality of circumferential notches.

16. The support column of claim 15, wherein the transitional position of the support column is one of a plurality of transitional positions in which the extension surface of each angled extension is not in face-sharing contact with the radial surface of the corresponding circumferential notch.

17. The support column of claim 16, wherein the fully extended position of the support column includes the first base of the first portion being a first distance from the second base of the second portion, a fully contracted position of the support column includes the first base being a second distance from the second base, wherein the fully extended position and fully contracted position are each one of the plurality of locked positions, and wherein the first distance is greater than the second distance.

18. A fuel system, comprising:
a fuel tank including:
at least one support column disposed within the fuel tank, the support column including:
a first portion and a second portion, with the first portion and second portion configured to move toward each other when pressed together and to not move away from each other when urged apart.

19. The fuel system of claim 18, further comprising a plurality of circumferential notches formed by an inner surface of the first portion and a plurality of angled extensions form by an outer surface of the second portion, with the plurality of angled extensions shaped to fit within the plurality of circumferential notches.

20. The fuel system of claim 19, wherein the first portion of the support column is coupled to a first wall of the fuel tank and the second portion of the support column is coupled to a second wall of the fuel tank, with the first wall arranged parallel and opposite to the second wall.
